(19) United States
(12) Patent Application Publication
(10) Pub. No.: US 2003/0220129 A1
(43) Pub. Date: Nov. 27, 2003

(54) Mobile phone with dual PCB structure

(75) Inventors: Long-Jyh Pan, Shijr City (TW); Hsiao-Wu Chen, Pingjen City (TW)

Correspondence Address: Richard P. Berg, Esq., c/o LADAS & PARRY`, Suite 2100, 5670 Wilshire Boulevard, Los Angeles, CA, 90036-5679, US

(73) Assignee: BENQ CORPORATION

(21) Appl. No.: 10/445,087

(22) Filed: May 20, 2003

(30) Foreign Application Priority Data
May 27, 2002 (TW) 91207694

(51) Int. Cl. H04M 1/00

(52) U.S. Cl. 455/575.1; 455/90.3

(57) ABSTRACT

A mobile phone with a dual PCB structure. The mobile phone includes a first PCB with electronic elements disposed thereon. A conductive enclosure is disposed on the first printed circuit board. A second printed circuit board has a plurality of layers and contacts the conductive enclosure. The first printed circuit board, the conductive enclosure and the second printed circuit board form a closed space within which the electronic elements are disposed. The first layer next to the conductive enclosure is an exposed copper layer grounded to protect the electronic elements from EMI.

### BACKGROUND OF THE INVENTION

1. Field of the Invention

The present invention relates to a mobile phone with a dual printed circuit board (PCB) structure, and in particular, a dual PCB structure with a metal ground layer to reduce electromagnetic interference (EMI).

2. Description of the Related Art

As technology improves, mobile phones must provide better communication quality, lower radiation, lower power consumption, smaller profile and more characteristic appearance. FIG. 1A is an exploded view of a conventional mobile phone. In FIG. 1A, the conventional mobile phone 10 includes a frame 13, a top shell 11, a bottom shell 14 and a main board 12. The frame 13 is plastic or metal for securing the main board 12, the top and bottom shell 11, 14. The main board 12 has a liquid crystal display module (LCD module) 121, a keypad PCB 123, an RF module (not shown) and other electronic elements (not shown).

In the past, electronic devices have usually been packaged with metal housings to reduce EMI and protect users from radiation. FIG. 1B is an exploded view of the main board of the mobile phone in FIG. 1A. In FIG. 1B, the main board 12 has two IC chips 124a, 124b with different functions, such as a CPU or a control IC of the RF-module. In order to shield the radiation produced by the IC chips 124a, 124b and prevent interaction between different modules, a conductive enclosure 122 is disposed on the main board 12 of the conventional mobile phone, and a metal cover 125a attaches to the conductive enclosure 122 and forms a closed space. The keypad PCB 123 is attached to the metal cover 125a from the top.

While the additional metal cover 125a and the conductive enclosure 122 reduce EMI, they also increase weight and enlarge the profile of the mobile phone 10. Thus, there is a need to modify this structure and to reduce the weight of the mobile phone.

### SUMMARY OF THE INVENTION

Accordingly, an object of the invention is to reduce the weight and number of elements of the mobile phone by modifying the PCB structure, eliminating the metal cover mentioned.

The present invention provides a dual PCB structure with EMI shielding. The dual PCB structure includes a conductive enclosure disposed on a first PCB and enclosing the electronic elements on the first PCB. A second PCB has a plurality of layers and contacts the conductive enclosure, such that the first PCB, the conductive enclosure and the second PCB form a closed space with the electronic elements disposed within. Moreover, the first layer next to the conductive enclosure is a grounded conductive layer to reduce EMI.

According to the invention, the first layer is an exposed copper layer and the other layers have at least one ground terminal, electrically connected to the first layer.

Moreover, the second printed circuit board attaches to the conductive enclosure by conductive foam sealing.

The present invention also provides a mobile phone having the dual PCB structure mentioned above. The first PCB of the dual PCB structure is fixed on a frame, and a shell detachably mounts on the frame to protect the elements inside.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is an exploded view of a conventional mobile phone as referenced in the Prior Art;

FIG. 1B is an exploded view of the main board of the mobile phone in FIG. 1A;

FIG. 2 is a partial cross section of the dual PCB structure of the invention;

FIG. 3A is an exploded view of the mobile phone of the invention; and

FIG. 3B is another exploded view of the main board of the mobile phone in FIG. 3A.

### DETAILED DESCRIPTION OF THE INVENTION

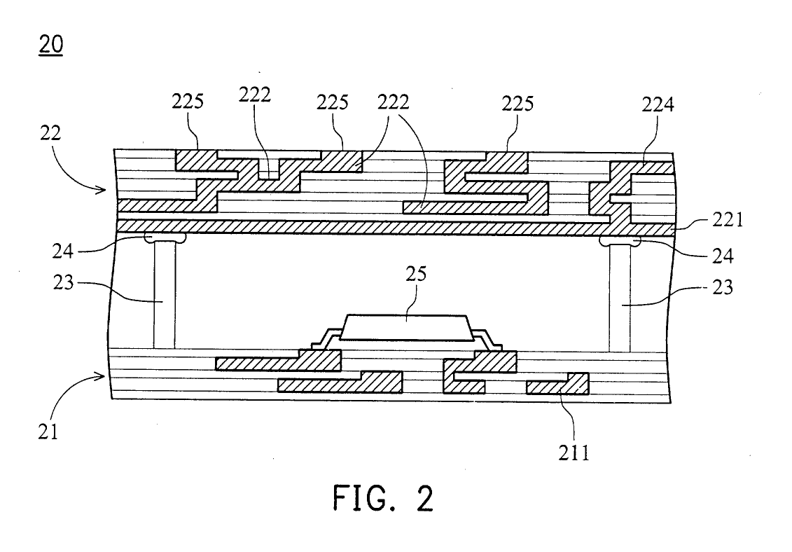

FIG. 2 is a partial cross section of the dual PCB structure of the invention. In FIG. 2, the dual PCB structure 20 of the invention includes a first PCB 21, a second PCB 22 and a conductive enclosure 23. The first PCB 21, or the main board of a mobile phone, has an IC chip 25 and a plurality of electronic elements (not shown) mounted thereon and electrically connected to the circuit 211 in the first PCB 21. The conductive enclosure 23 is metal or other conductors. It is adhered or welded to the first PCB 21. Furthermore, the second PCB 22, or the key PCB of the mobile phone, contacts the conductive enclosure 23, such that the first PCB 21, the conductive enclosure 23 and the second PCB 22 form a closed space and enclose the IC chip 25.

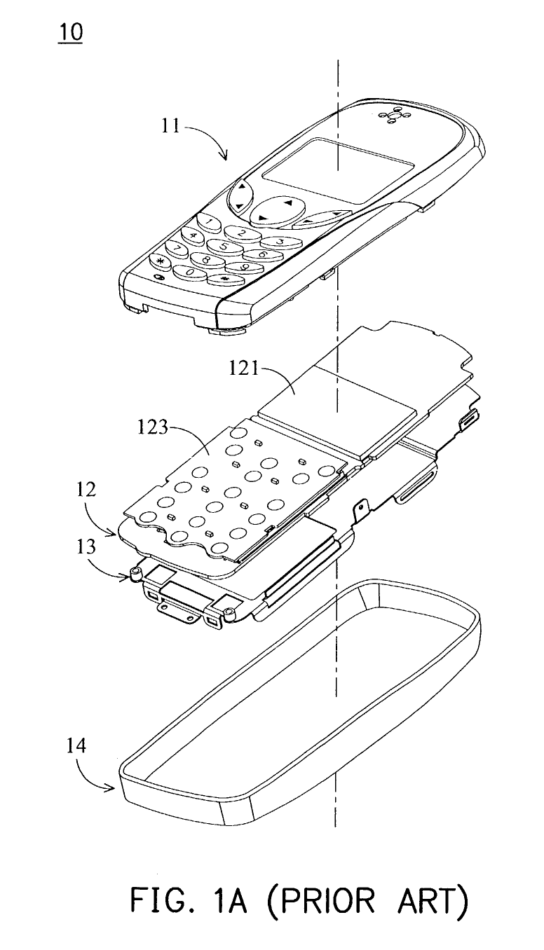

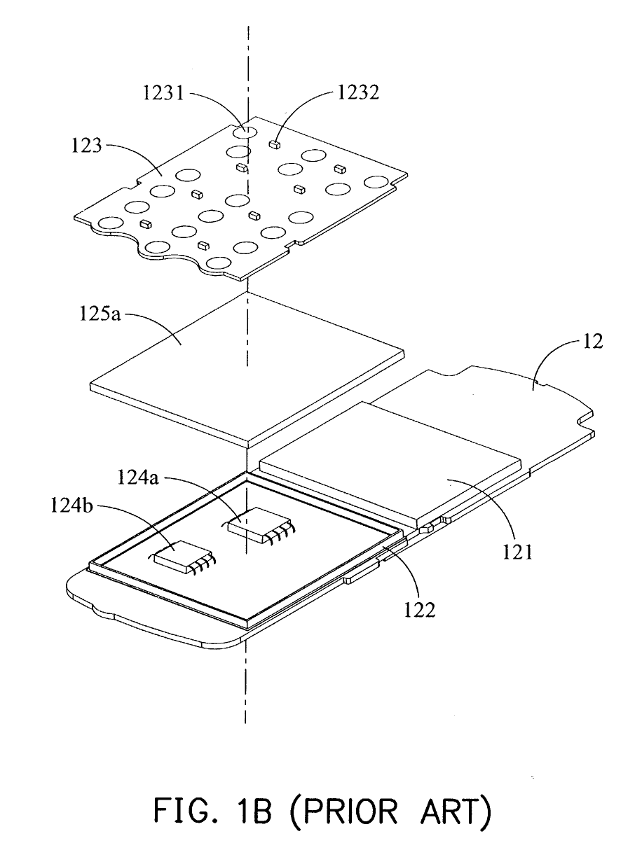

In FIG. 2, the second PCB is multi-layered. The first layer 221 next to the conductive enclosure 23 is a pure conductive layer without any predetermined circuit; that is, the second PCB 22 is an exposed copper layer. The circuit 222 of the keypad is designed between the other layers of the second PCB 22, or the keypad PCB. The circuit 222 is electrically connected to other electronic devices through the electrodes 225. Moreover, the first layer 221 of the second PCB 22 does not have any insulation layer or resin layer on the surface. It is connected to the ground terminal 224 of the second PCB 22 and forms a grounded metal layer. The second PCB 22 is adhered to the conductive enclosure 23 by conductive foam 24 or glue. Thus, is the first layer 221 of the second PCB 22 and the conductive enclosure 23 form an EMI shield, which absorbs the radiation produced by the IC chip 25 to protect users. Accordingly, the dual PCB structure 20 of the invention can reduce EMI by the exposed copper layer of the second PCB 22 without the additional metal cover 125a shown in FIG. 1B.

In order to specify the dual PCB of the invention, the following embodiment takes a mobile phone for an example.

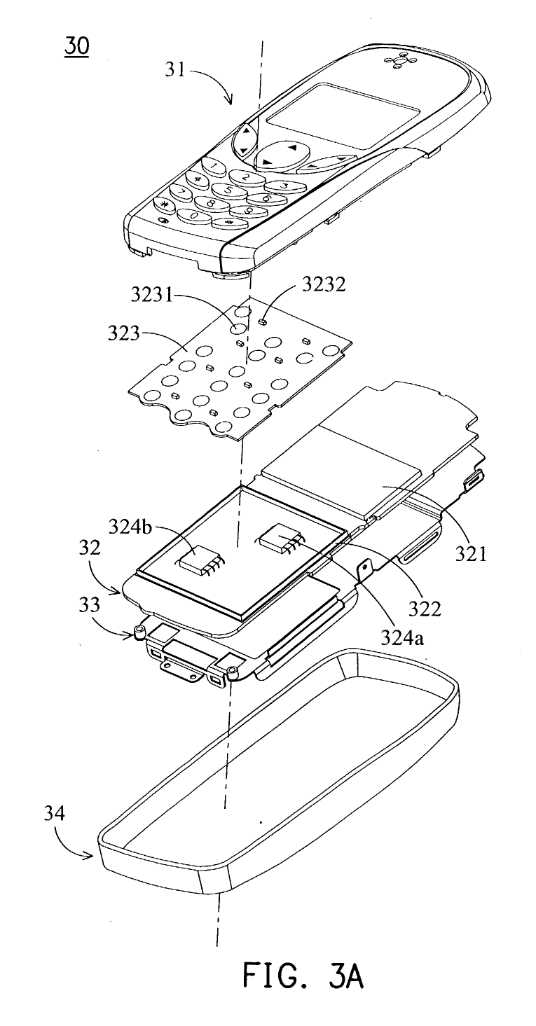

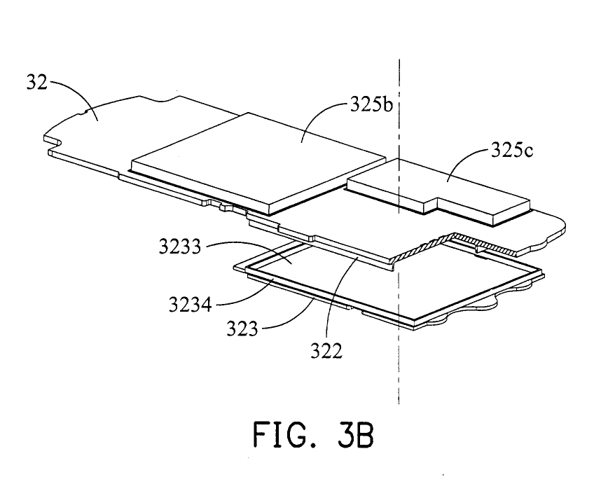

FIG. 3A is an exploded view of the mobile phone of the invention, and FIG. 3B is another exploded view of the main board in FIG. 3A. In FIGS. 3A and 3B, the mobile phone 30 also includes a frame 33, a top shell 31, a bottom shell 34 and a main board 32. The frame 33 is plastic or metal for securing the main board 32, the top and bottom shell 31, 34. The main board 32 has a liquid crystal display module (LCD module) 321, and a keypad PCB 323. The main board 32 of the mobile phone 30 also has two IC chips 324a, 324b surrounded by a conductive enclosure 322 under the keypad PCB 323. The conductive enclosure 322 is metal or other conductive materials. On the back of the main board, there are several electronic elements (not shown) covered by two metal covers 325a, 325b (in FIG. 3B) to isolate radiation and reduce EMI.

The keypad PCB 323 of the invention is multi-layered with a plurality of metal electrodes 3231 and LEDs 3232 on the surface. The LEDs 3232 can illuminate the keypad. The electrodes 3231 send command signals to the CPU on the main board 32 of the mobile phone 30 when contacted by the keys of the top shell 31. Referring to FIG. 3B, the first layer 3233 of the keypad PCB 323 does not have any predetermined circuit. It can be an unetched and exposed copper layer because the keypad PCB 323 is multi-layered, and the circuit of the keypad is not complicated. The first layer 3233 of the keypad PCB 323 does not have any insulation layer or resin layer on the surface. It is grounded and forms a grounded metal layer. When the first layer 3233 of the keypad PCB 323 contacts the conductive enclosure 322, the first layer 3233 of the keypad PCB 323 and the conductive enclosure 322 form an EMI shield to absorb the radiation produced by the IC chips 324a, 324b disposed inside. Thus, the metal cover 125a shown in FIG. 1B can be replaced by the dual PCB structure of the invention.

In FIGS. 3A and 3B, when assembling the mobile phone 30, the keypad PCB 323 is adhered to the conductive enclosure 322 by conductive foam 3234 or glue, or the main board 32 and the keypad PCB 323 are sequentially engaged or bolted to the frame 33. The main board 32, the keypad PCB 323 and the conductive enclosure 322 form a closed space. This dual PCB structure absorbs radiation produced by IC chips 324a, 324b because the first layer 3233 of the keypad PCB 322 is grounded and is an exposed copper layer. The conductive foam 3234 disposed on the backside of the keypad PCB 322 can bond the keypad PCB 323 and the conductive enclosure 322. It also absorbs radiation and reduces EMI.

The keypad PCB 322 of the mobile phone 30 can execute predetermined functions and absorb radiation. Thus, the mobile phone 30 of the invention does not require an additional metal cover, reducing the weight of the mobile phone 30.

Moreover, the inventive dual PCB structure can not only be used in mobile phones, but also PDAs, notebooks, digital cameras, and other electronic devices.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A dual printed circuit board structure, comprising:
a first printed circuit board, having a plurality of electronic elements;
a conductive enclosure, disposed on the first printed circuit board; and
a second printed circuit board, having a plurality of layers and contacting the conductive enclosure, wherein a first layer next to the conductive enclosure is a grounded conductive layer, the first printed circuit board, the conductive enclosure and the second printed circuit board form a closed space with the electronic elements disposed therein.

2. The dual printed circuit board structure as claimed in claim 1, wherein the first layer is an exposed copper layer.

3. The dual printed circuit board structure as claimed in claim 1, wherein the plurality of layers have at least one ground terminal, electrically connected to the first layer.

4. The dual printed circuit board structure as claimed in claim 1, wherein the second printed circuit board is attached to the conductive enclosure by conductive foam.

5. A mobile phone, comprising:
a first printed circuit board, having a plurality of electronic elements;
a conductive enclosure, disposed on the first printed circuit board; and
a second printed circuit board, having a plurality of layers and contacting the conductive enclosure, wherein the first printed circuit board, the conductive enclosure and the second printed circuit board form a closed space with the electronic elements disposed therein, and a first layer disposed in the second printed circuit board next to the conductive enclosure is a grounded conductive layer.

6. The mobile phone as claimed in claim 1, wherein the first layer is an exposed copper layer.

7. The mobile phone as claimed in claim 1, wherein the plurality of layers have at least one ground terminal, electrically connected to the first layer.

8. The mobile phone as claimed in claim 1, wherein the second printed circuit board attaches to the conductive enclosure by conductive foam.
